(19) United States
(12) Patent Application Publication
(10) Pub. No.: US 2014/0369387 A1
(43) Pub. Date: Dec. 18, 2014

(54) METHOD FOR THE TEMPERATURE MEASUREMENT OF SUBSTRATES IN A VACUUM CHAMBER

(71) Applicants: Siegfried Krassnitzer, Feldkirch (AT); Markus Esselbach, Feldkirch (AT)

(72) Inventors: Siegfried Krassnitzer, Feldkirch (AT); Markus Esselbach, Feldkirch (AT)

(73) Assignee: OERLIKON TRADING AG, TRUBBACH, Trubbach (CH)

(21) Appl. No.: 14/345,019

(22) PCT Filed: Sep. 7, 2012
(86) PCT No.: PCT/EP2012/003759

§ 371 Date: Apr. 10, 2014

Related U.S. Application Data
(60) Provisional application No. 61/534,943, filed on Sep. 15, 2011.

(51) Int. Cl. G01K 7/10; G01K 7/04

(52) U.S. Cl. CPC G01K 7/10; G01K 7/04
USPC 374/181

(57) ABSTRACT

The present invention relates to a temperature-measuring system, comprising a temperature sensor and a reference body, wherein means for determining temperature changes of the reference body and/or for control of the temperature of the reference body are provided. When the temperature measuring-system is used in a vacuum, the reference body forms no substantial material thermal bridges to the temperature sensor and the reference body shields the temperature sensor with respect to the environment in such a way that only radiation that comes from the surfaces of the reference and from surfaces of which the temperature is to be determined reaches the surface of the temperature sensor.

The present invention relates to a method for the contactless measurement of the temperature of a substrate during its treatment in a chamber, in particular during a surface treatment such as for example heating, etching, CVD and/or PVD coating in a vacuum chamber.

### STATE OF THE ART

Controlling the substrate temperature when performing a CVD and/or PVD coating process often plays a very important role. This is the case for example if temperature-sensitive substrates are to be provided with a functional coating or also if the temperature existing during the coating influences the properties of the layer material, which is generally the case.

During the coating, the components to be coated are moved frequently in order to generate a homogenous layer. Often, in particular in the case of complex geometries of the components, a double or triple rotation is performed, This makes it difficult to place temperature sensors directly onto the components to be coated.

In this connection, the following temperature measuring methods are used for determining the substrate temperature:
1. Measurement of the substrate temperature with infrared sensors from outside: in this case, the temperature of the substrates going past is measured by means of infrared temperature measuring devices through a special window that allows infrared radiation to pass through, In this connection, the disadvantages of this temperature measuring method are mainly the following: a) the degree of emissions of the surface must be known, b) the window must be protected from layer deposits during the coating and/or be subjected regularly to a de-coating.
2. Measurement with thermocouple in the chamber:
   2.1 Co-rotating thermocouple: in this case, the thermocouple must be mounted on the substrate holder so as to move simultaneously and the cables of the thermocouple must be lead through a rotary leadthrough out of the vacuum receptacle. Such a measurement as a rule reflects the substrate temperature very well, the complexity of the rotary leadthrough is however considerable.
   2.2 Stationary thermocouple: in this case, a thermocouple is mounted in a stationary manner in the chamber statically between the walls of the vacuum chamber and the moving substrate. According to the slate of the art, the corresponding measurement provides conditionally exact results limited both over time as well as in terms of absolute temperature value. In order to achieve reasonably exact measurement results, it is necessary to wait until the vacuum chamber and the substrates are in thermal equilibrium. Experience furthermore shows that the measurement result depends strongly on the position of the sensor.

### TASK OF THE INVENTION

There is therefore a need for a reliable method for measuring the temperature of substrates moved in a vacuum chamber. It would be desirable in this respect to be able to resort to the thermocouples affixed in a stationary manner in the vacuum chamber. In this respect, a measuring method should be proposed that supplies more reliable values as compared with the state of the art.

### SOLUTION TO THE TASK

The task is solved according to the invention in that additionally to the stationary temperature sensor in the vicinity of the sensor a reference of known and/or adjustable temperature is provided in the vacuum chamber. The reference thereby shields the temperature sensor in such a way against the environment that the surface of the temperature sensor receives only radiation coming from the surfaces of the reference and coming from surfaces whose temperature is to be determined. This can be achieved for example in that the reference is executed in a cup shape on the bottom of which the surface of the temperature sensor is mounted in a manner insulated from one another and in that the cup is oriented in such a manner that its opening points in the direction of the substrates to be measured.

### DESCRIPTION OF THE INVENTION

In order to explain the invention more accurately, it is useful to briefly address the underlying theory. In a theoretical case of infinitely extended surfaces, the temperatures of the substrate surface, sensor surface and reference surface behave as follows, provided the sensor surface is placed between the reference surface and the substrate surface and the system is in thermal equilibrium:

T_{substrate surface}⁴=2·T_{sensor surface}⁴−T_{reference surface}⁴ Equation 1:

Thus, if the temperature of the reference surface is known and the temperature of the sensor (temperature of the sensor surface) has been measured, the substrate temperature can be determined by means of the simple relation expressed in equation 1.

In the special case of a very cold reference surface, i.e. if T_{reference surface}⁴<<T_{sensor surface}⁴, the equation 1 is simplified to:

T_{substrate surface}=1.1892 T_{sensor surface} Equation 2:

The factor of 1.1892 (≈2^{1/4}) is called the irradiating number in the case of infinitely extended plates. For other real geometries there are other irradiating numbers which can be determined by using other methods, such as for example the finite element method or the radiosity method. A known finite-element software in this relation is known under the name Ansys.

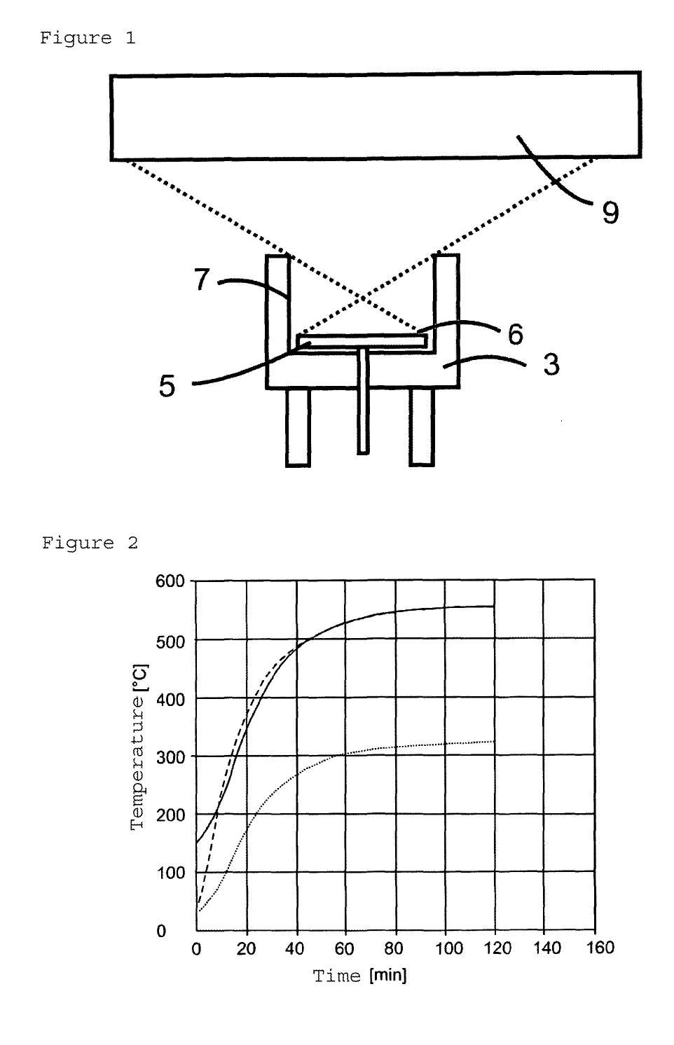

FIG. 1 shows a first embodiment of the present invention. According to this embodiment, a reference 3 executed in a cup shape and with a reference surface 7 is attached in a vacuum chamber (not shown), wherein at the bottom of the cup a temperature sensor 5 with a sensor surface 8 is provided. The heat-sensitive surface of the temperature sensor can only be reached by such rays that either originate inside the cup wall (reference surface 7) or come from a direction that lies within the cone indicated in FIG. 1 by means of the dashed line. If the cup opening is oriented in the direction of the substrate 9 as indicated in FIG. 1, the sensor surface receives essentially exclusively the radiation from the reference surface and the substrate surfaces.

According to the first embodiment, the temperature of the reference surface and of the surface of the temperature sensor is then measured and the attempt is made to adjust the temperature of the reference surface to the temperature of the surface of the temperature sensor. Due to the radiation originating from the reference surface, a modification of the temperature on the reference surface will entail a change of the temperature at the surface of the temperature sensor as long as the temperature of the reference surface does not correspond to the temperature of the substrate surface. It is only when the substrate temperature has been reached that the reference surface, sensor surface and substrate surfaces constantly have the same temperature. By tracking the reference temperature, it is thus possible according to the invention to determine very accurately the temperature of the substrates. This works among others particularly well because the whole process takes place under vacuum conditions without influence from disruptive factors of a surrounding atmosphere. This method is suitable especially for measuring moderate substrate temperatures, such as for example those that must prevail during the coating of plastic substrates.

For higher temperatures of the substrates, for example for substrate temperatures higher than 200° C. a method according to a second embodiment of the present invention is preferably used. In principle, when the temperature of the reference and the temperature of the sensor are known, the substrate temperature can be extrapolated. On the one hand the corresponding dependency can be determined by means of the simulation already mentioned above. On the other hand, it is however also possible to first calibrate the system by having a thermocouple carried with the substrates in a rotatable (co-rotational) manner and these are brought to different temperatures. In this case, the reference surface is preferably maintained at a constant temperature and the temperature measured at the sensor surface is brought in relation to the temperature measured at the co-rotating thermocouple.

One special case of the second embodiment of the present invention described above occurs when the temperature of the reference surface is chosen so small as compared to the temperature of the substrate surfaces that T_{reference surface}⁴<<T_{sensor surface}⁴. In a manner analogous to equation 2, the contribution of the reference surface can be disregarded and the substrate temperature is then in a simple relation to the measured sensor temperature. It was possible to prove experimentally that in the case where the temperature of the reference surface is sufficiently low to be disregarded, the evolution of the temperature can be very well described by means of equation 3:

T_{substrate surface}=k*T_{sensor surface} Equation 3:
wherein k: irradiating number with respect to the real geometric relations

This is documented in FIG. 2, which shows the evolution of the temperature
of the “real” substrate temperature, measured with a thermocouple co-rotating with the substrates for the purpose of calibration (dashed line),
of the temperature of the sensor surface (T_{sensor surface}), measured with the temperature sensor that is stationary yet inventively placed in the vacuum chamber (dotted line), and
of the substrate temperature (T_{substrate surface}) calculated according to the invention, which is calculated according to equation 3 (unbroken line)
   according to the time.

For the inventive calculation of the substrate temperature (T_{substrate surface}), the irradiation number k=1.4 was used, as determined by using the known finite-element software Ansys.

The evolution of the temperature was achieved by heating the substrates. FIG. 2 clearly shows that from a substrate temperature of 500° C., the temperature of the reference surface, which was 80° C., can be disregarded.

A temperature-measuring system, comprising a temperature sensor and a reference body, has been disclosed wherein means for determining temperature changes of the reference body and/or for controlling the temperature of the reference body are provided, wherein the reference body, when the temperature-measuring system is used in a vacuum, forms no substantial material thermal bridges to the temperature sensor and the reference body shields the temperature sensor with respect to the environment in such a way that only radiation that comes from the surfaces of the reference and from surfaces of which the temperature is to be determined reaches the surface of the temperature sensor.

In the temperature-measuring system, the reference body can be executed as a cup with a cup bottom and the temperature sensor can be placed near the cup bottom yet in a manner thermally insulated from the latter.

A vacuum treatment facility can be equipped with such a temperature-measuring system. The reference is preferably oriented in such a manner that essentially only radiation that comes from the surfaces of the reference and from surfaces of the substrates to be treated in the vacuum facility resp. possibly from the substrate holders reaches the surface of the temperature sensor.

A method for measuring the temperature of substrates in a vacuum treatment chamber has been disclosed, comprising the following steps:
determining a first sensor measurement value of a temperature sensor
determining a first reference measurement value of a reference body
determining the substrate temperature by using the sensor measurement value and the temperature measurement value.

The sensor measurement value can in this respect correspond to the temperature of the sensor and the reference measurement value can correspond to the actual temperature of the reference body. The repeated approximation of the temperature of the reference body to the temperature of the sensor results in that, at a stable temperature, the temperature of the reference body is stable and equal to the temperature of the sensor and thus the sensor, the reference body and the substrates have the same temperature.

What is claimed is:

1. Temperature-measuring system, comprising a temperature sensor and a reference body, characterized in that means for determining temperature changes of the reference body and/or for controlling the temperature of the reference body are provided, wherein the reference body, when the temperature-measuring system is used in a vacuum, forms no substantial material thermal bridges to the temperature sensor and the reference body shields the temperature sensor with respect to the environment in such a way that only radiation that comes from the surfaces of the reference and from surfaces of which the temperature is to be determined reaches the surface of the temperature sensor.

2. Temperature-measuring system according to claim 1, characterized in that the reference body is executed as a cup with a cup bottom and the temperature sensor can be placed near the cup bottom yet in a manner thermally insulated from the latter.

3. Vacuum treatment facility with a temperature-measuring system according to claim 1, characterized in that the reference is oriented in such a manner that essentially only radiation that comes from the surfaces of the reference and from surfaces of the substrates to be treated in the vacuum facility and possibly from the substrate holders reaches the surface of the temperature sensor.

4. Method for measuring the temperature of substrates in a vacuum treatment chamber, comprising the following steps:
determining a first sensor measurement value of a temperature sensor
determining a first reference measurement value of a reference body
determining the substrate temperature by using the sensor measurement value and the temperature measurement value.

5. Method according to claim 4, characterized in that the sensor measurement value corresponds to the temperature of the sensor and the reference measurement value corresponds to the actual temperature of the reference body and the repeated approximation of the temperature of the reference body to the temperature of the sensor results in that, at a stable temperature, the temperature of the reference body is stable and equal to the temperature of the sensor and thus the sensor, the reference body and the substrates have the same temperature.
